(19) United States
(12) Patent Application Publication
(10) Pub. No.: US 2021/0116740 A1
(43) Pub. Date: Apr. 22, 2021

(54) STARTUP CONTROL METHOD FOR LIQUID CRYSTAL DISPLAY DEVICE AND LIQUID CRYSTAL DISPLAY DEVICE

(71) Applicant: Shenzhen China Star Optoelectronics Semiconductor Display Technology Co., Ltd., Shenzhen (CN)

(72) Inventor: Xianming Zhang, Shenzhen (CN)

(21) Appl. No.: 16/304,303

(22) PCT Filed: Sep. 20, 2018
(86) PCT No.: PCT/CN2018/106601

§ 371 Date: Nov. 26, 2018

(30) Foreign Application Priority Data
Jul. 9, 2018 (CN) 201810747021.8

(51) Int. Cl. G02F 1/1333; G09G 3/36; G09G 3/34

(52) U.S. Cl. CPC G02F 1/133382; G09G 3/36; G09G 2320/041; G09G 2330/026; G09G 3/3406

(57) ABSTRACT

A startup control method for liquid crystal display device and liquid crystal display device are disclosed. The method includes a step 10, detecting an ambient temperature before turning on; a step 20, determining whether the ambient temperature is higher than or equal to a first temperature; a step 30, if the ambient temperature is higher than or equal to the first temperature, controlling the liquid crystal display device to be normally turned on; otherwise, performing a step 40; the step 40, determining whether the ambient temperature is higher than or equal to the second temperature, wherein the second temperature is lower than the first temperature; and a step 50, if the ambient temperature is higher than or equal to the second temperature, controlling a backlight module to be fully turned on in order to heat a liquid crystal panel, and then returning to the step 10.

### FIELD OF THE INVENTION

The present invention relates to a display technology field, and more particularly to a startup control method for liquid crystal display device and a liquid crystal display device.

### BACKGROUND OF THE INVENTION

The liquid crystal display has many advantages such as thin body, power saving, no radiation, and has been widely used. For example: LCD TV, mobile phone, personal digital assistant (PDA), digital camera, computer screens or laptop screens, etc. The liquid crystal display dominates the field of the flat panel display.

Most of the liquid crystal displays on the market are the backlight type liquid crystal displays, including a liquid crystal panel and a backlight module. The backlight module is one of the key components of the liquid crystal display. Since the liquid crystal panel itself cannot emit light, the function of the backlight module is to provide a sufficient light source and a uniformly distributed light source to enable the liquid crystal display to normally display an image. The existing backlight module is generally an LED backlight module using an LED (Light Emitting Diode) as a light source.

The GOA (Gate Driver on Array) technology is a TFT (Thin Film Transistor) liquid crystal display array process that forming a gate scan driving circuit on a thin film transistor array substrate to realize a progressive scan driving method, which has advantages of a low production cost and realizes a narrow bezel design liquid crystal panel so that the GOA (Gate Driver on Array) technology is adopted by multiple display devices.

The problem of low-temperature startup is a problem often encountered in the GOA (Gate Driver on Array) technology. Due to the characteristic drift of the thin-film transistor at low temperature, it is unable to be turned on at a low temperature or the startup is abnormal, and display problems are generated. The prior art uses the VGH voltage (gate turn-on voltage) for temperature compensation, and uses a higher gate-on voltage at a low temperature to enable the thin-film transistor to be normally turned on and displayed normally. However, this method only ensures that the thin-film transistor can be normally turned on, and the change in characteristics in the liquid crystal panel cannot be improved, and if the liquid crystal display device is turned on at a lower temperature, there is also a chance that the image is abnormal. When the liquid crystal display is in a low temperature environment, problems such as slow reaction, residual image, contrast drop, and uneven color are likely to occur due to low temperature, which greatly affects display quality.

### SUMMARY OF THE INVENTION

Therefore, an object of the present invention is to provide a startup control method for liquid crystal display device. When startup, detecting an ambient temperature and performing a corresponding startup operations according to the temperature range.

Another object of the present invention is to provide a liquid crystal display device. When startup, detecting an ambient temperature and performing a corresponding startup operations according to the temperature range.

In order to realize the above purpose, the present invention provides a startup control method for liquid crystal display device, comprising:

a step 10, detecting an ambient temperature before turning on;

a step 20, determining whether the ambient temperature is higher than or equal to a first temperature;

a step 30, if the ambient temperature is higher than or equal to the first temperature, controlling the liquid crystal display device to be normally turned on;

otherwise, performing a step 40;

the step 40, determining whether the ambient temperature is higher than or equal to the second temperature, wherein the second temperature is lower than the first temperature; and

a step 50, if the ambient temperature is higher than or equal to the second temperature, controlling a backlight module to be fully turned on in order to heat a liquid crystal panel, and then returning to the step 10.

Wherein the method further comprises a step of: a step 60, if the ambient temperature is lower than the second temperature, controlling the liquid crystal display device not to be turned on.

Wherein the step 60 further comprises a step of: controlling the liquid crystal display device to generate an alarm message.

Wherein the first temperature is 0° C., the second temperature is minus 20° C.

Wherein in the step S50, the backlight module is fully turned on to heat the liquid crystal panel through PWM dimming, analog dimming, and/or backlight turning on signal.

Wherein in the step S10, through a temperature detection circuit to detect the ambient temperature.

Wherein the temperature detection circuit comprises a thermistor, and through detecting a divided voltage on the thermistor to represent the ambient temperature.

Wherein the first temperature and the second temperature are respectively represented as a first voltage and a second voltage, confirming the temperature range by comparing the first voltage and the second voltage with the divided voltage, respectively.

Wherein through comparators to compare the first voltage and the second voltage with the divided voltage.

The present invention also provides a liquid crystal display device, comprising: a detection module for detecting an ambient temperature before turning on; a first determination module for determining whether the ambient temperature is higher than or equal to a first temperature; a startup module for controlling the liquid crystal display device to be normally turned on if the ambient temperature is higher than or equal to the first temperature; a second determination module for determining whether the ambient temperature is higher than or equal to a second temperature when the ambient temperature is lower than the first temperature, wherein the second temperature is lower than the first temperature; and a heating module for controlling the backlight module to be fully turned on to heat the liquid crystal panel if the ambient temperature is higher than or equal to the second temperature.

In summary, the startup control method for liquid crystal display device and the liquid crystal display device of the present invention detect the ambient temperature before turning on the device, and if the ambient temperature is greater than the first temperature, the device is normally turned on; if the ambient temperature is lower than the first temperature but above the second temperature, the liquid crystal panel is heated by the backlight with high power, and then the liquid crystal display device is turned on after the ambient temperature is restored. The liquid crystal display device of the present invention is prevented from operating at a low temperature to protect the liquid crystal display device.

### BRIEF DESCRIPTION OF THE DRAWINGS

The technical solutions and other advantageous effects of the present invention will be apparent from the following detailed description of embodiments of the invention.

In the figures,

FIG. 1 is a flow chart of a startup control method for liquid crystal display device of the present invention.

FIG. 2 is a schematic diagram of a temperature detecting circuit according to a preferred embodiment of the startup control method for liquid crystal display device of the present invention.

FIG. 3 is a schematic diagram of a circuit principle for confirming a temperature range according to a preferred embodiment of the startup control method for liquid crystal display device of the present invention.

FIG. 4 is a block diagram of the structure of a liquid crystal display device according to a preferred embodiment of the present invention.

### DETAILED DESCRIPTION OF PREFERRED EMBODIMENTS

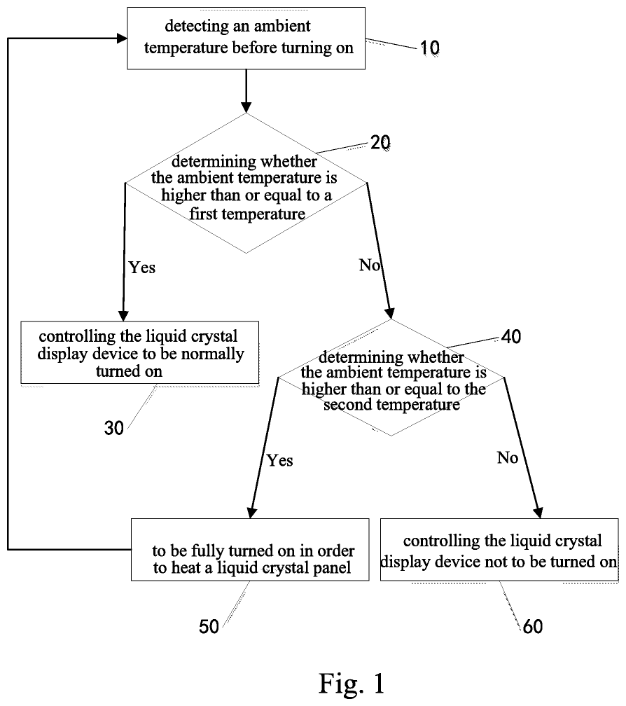

Referring to FIG. 1, which is a flowchart of a startup control method for liquid crystal display device of the present invention. The startup control method for liquid crystal display device of the present invention mainly comprises steps of:

Step 10: detecting an ambient temperature before turning on; for a liquid crystal display device such as a liquid crystal television, which is mainly formed by a backlight module (BLU) and a liquid crystal panel, the backlight module is generally formed by multiple LEDs and a backlight driver; When the liquid crystal television turns on, using a system on chip (SOC) to detect the ambient temperature to determine the ambient temperature of the liquid crystal panel; two temperature protection points can be preset: a first temperature, that is, the low temperature set point, for example, 0° C., which can be set to a critical temperature that can be normally turned on; and a second temperature, that is, a severe temperature point, for example, −20° C., which can be set as a critical temperature required to be turned on after heating; wherein the second temperature is lower than the first temperature, That is, the severe temperature point is lower than the low temperature set point;

Step 20: determining whether the ambient temperature is higher than or equal to the first temperature; comparing the ambient temperature with the preset first temperature, determining a range of the ambient temperature;

Step 30: if the ambient temperature is higher than or equal to the first temperature, controlling the liquid crystal display device to be normally turned on; otherwise, performing a step 40; if the ambient temperature is higher than or equal to the first temperature, proving that the liquid crystal panel is operating under a normal ambient temperature so that the liquid crystal panel can turn on normally;

Step 40: determining whether the ambient temperature is higher than or equal to the second temperature, wherein the second temperature is lower than the first temperature; comparing the ambient temperature with the preset second temperature, determining the range of the ambient temperature;

Step 50: if the ambient temperature is higher than or equal to the second temperature, controlling the backlight module to be fully turned on in order to heat the liquid crystal panel, and then returning to the step 10; presetting a time that the backlight module heats the liquid crystal panel, and after heating for a certain period of time, returning to the step 10 to re-detecting the ambient temperature, and then perform the startup control according to the detected ambient temperature.

Applying the startup control method of the present invention, if the ambient temperature is lower than the first temperature but above the second temperature, the liquid crystal panel is heated by the backlight module with high power before being turned on, and then turned on after the temperature is restored. The present invention utilizes the backlight module to perform the heating without additional heating means so that the design is simple and the cost is effective. When using the backlight module for heating, the system on chip of the liquid crystal display device fully turns on the backlight module through PWM (pulse width modulation) dimming, analog dimming, and/or BLON (backlight turning on) signals. Furthermore, according to the current resistance of the LED, driving the LED by a current larger than a normal operation to heat the backplane and the liquid crystal panel. After the temperature is increased, turning on the liquid crystal panel normally. According to the current temperature of the LED backlight module, the temperature of the liquid crystal panel can be increased up to 20° C. If the driving current is increased, the temperature can be increased above the first temperature in a short time.

The method may further include: a step 60, if the ambient temperature is lower than the second temperature, controlling the liquid crystal display device not to be turned on. The method can further comprise a step of: controlling the liquid crystal display device to generate an alarm message. The present invention can be designed that if the ambient temperature before turning on is detected as being below the second temperature, the liquid crystal display device will not turn on to prevent the permanent damage of the liquid crystal panel caused by the bad TFT characteristics after turning on. If the ambient temperature is lower than the second temperature, the system on chip of the liquid crystal display device will not perform the startup operation, but the speaker can be selected to inform the user that the temperature is too low to be turned on. The method of the present invention can realize the detection of low temperature, ensure that the liquid crystal display device can work normally at a temperature lower than −20° C., and protects under a more severe low temperature condition to prevent the liquid crystal display device from being damaged.

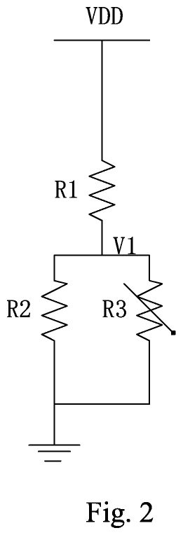

FIG. 2 is a schematic diagram of a temperature detection circuit according to a preferred embodiment of the startup control method of the present invention, which is used to illustrate a circuit that can be used when the system on chip detects the ambient temperature, and the basic circuit is as follows. A second resistor R2 and a thermal resistor R3 is connected in parallel between one end of a first resistor R1 and a ground, and the other end of the first resistor R1 is connected to an operation voltage VDD, and the operation voltage VDD is voltage divided by the first resistor R1, the second resistor R2 and the thermistor R3 to obtain a divided voltage V1. In this embodiment, the ambient temperature is represented by detecting the divided voltage V1 on the thermistor R3.

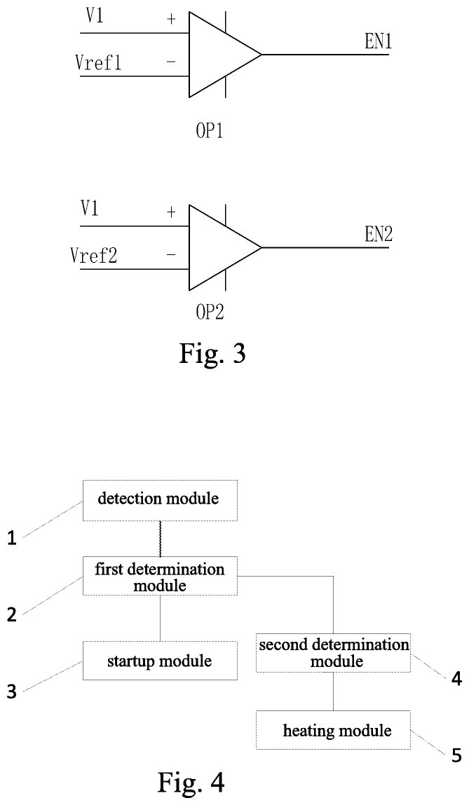

FIG. 3 is a schematic diagram of a circuit principle for confirming a temperature range according to a preferred embodiment of the startup control method of the present invention. Corresponding to the divided voltage V1 that represents the ambient temperature, in this embodiment, the preset first temperature and the second temperature may be respectively represented as a first voltage Vref1 and a second voltage Vref2, wherein the first voltage Vref1 represents the first temperature, the second voltage Vref2 represents a second temperature, and the first voltage Vref1<the second voltage Vref2. Confirming the temperature range by comparing the first voltage Vref1 and the second voltage Vref2 with the divided voltage V1, respectively. As shown in FIG. 3, the comparison can be performed by a first comparator OP1 and a second comparator OP2. The first comparator OP1 inputs the divided voltage V1 at the non-inverting input terminal, and the first voltage Vref1 is inputted to the inverting input terminal to output a first comparison result EN1. The second comparator OP2 inputs the divided voltage V1 at the non-inverting input terminal, the second voltage Vref2 is inputted to the inverting input terminal, and a second comparison result EN2 is outputted. The configuration of the input terminals of the first voltage Vref1, the second voltage Vref2 and the comparator are related to the temperature coefficient of the thermistor R3. In the preferred embodiment, the thermistor R3 is a negative temperature coefficient; when the thermistor R3 is a positive temperature coefficient, the above configuration can be adjusted correspondingly.

After the first comparator OP1 and the second comparator OP2 compare the first voltage Vref1 and the second voltage Vref2 with the divided voltage V1, and generating the first comparison result EN1 and the second comparison result EN2, a truth table for the first comparison result EN1/the second comparison result EN2 is obtained as shown in Table 1 below, which is used to represent different startup operations, and can perform a next action through the system-on-chip according to the corresponding result. The system on chip can select a corresponding startup operation according to the preset truth table according to the obtained value of the first comparison result EN1/the second comparison result EN2.

TABLE 1
truth table of first comparison result
EN1/second comparison result EN2

| EN1 | EN2 | Startup operation |
|---|---|---|
| 0 | 0 | Normal startup |
| 1 | 0 | Low temperature startup, control |
| | | the backlight module to perform a |
| | | heating action and then turning on |
| 1 | 1 | TV protection, no startup action |

It can be understood by those skilled in the art that the circuit structure shown in FIG. 2 and FIG. 3 is simple and easy to implement, and is only used to illustrate the present invention. Other circuits and/or functional modules that can implement corresponding functions can also be used in the present invention.

Those skilled in the art can understand that all or part of the steps in the startup control method of the present invention can be completed by hardware, or can be controlled by a program to control related hardware. Accordingly, the present invention provides a liquid crystal display device. Referring to FIG. 4, which is a structural block diagram of a liquid crystal display device according to a preferred embodiment of the present invention, and the device mainly includes: a detection module 1 for detecting an ambient temperature before turning on; when turning on, the system on chip can be used to detect the ambient temperature to determine the ambient temperature of the liquid crystal panel; a first determination module 2 for determining whether the ambient temperature is higher than or equal to a first temperature, a startup module 3 for controlling the liquid crystal display device to be normally turned on if the ambient temperature is higher than or equal to the first temperature; and if the ambient temperature is higher than or equal to the first temperature, the liquid crystal panel is proved to work under a normal ambient temperature, which can turn on normally, a second determination module 4 for determining whether the ambient temperature is higher than or equal to a second temperature when the ambient temperature is lower than the first temperature, when the ambient temperature is lower than the first temperature, determining whether the liquid crystal panel can be heated by determining whether the ambient temperature is higher than or equal to the second temperature, and a heating module 5 for controlling the backlight module to be fully turned on to heat the liquid crystal panel if the ambient temperature is higher than or equal to the second temperature. The backlight module can be preset to heat the liquid crystal panel. After heating for a certain period of time, the detection module 1 is used to re-detect the ambient temperature, and then each module is used for startup control according to the detected ambient temperature.

In summary, the startup control method for liquid crystal display device and the liquid crystal display device of the present invention detect the ambient temperature before turning on the device, and if the ambient temperature is greater than the first temperature, the device is normally turned on; if the ambient temperature is lower than the first temperature but above the second temperature, the liquid crystal panel is heated by the backlight with high power, and then the liquid crystal display device is turned on after the ambient temperature is restored. The liquid crystal display device of the present invention is prevented from operating at a low temperature to protect the liquid crystal display device.

In the above, for those of ordinary skill in the art, various other changes and modifications can be made in accordance with the technical solutions and technical concept of the present invention, and all such changes and modifications are intended to be included within the scope of the appended claims.

What is claimed is:

1. A startup control method for liquid crystal display device, comprising:
a step 10, detecting an ambient temperature before turning on;
a step 20, determining whether the ambient temperature is higher than or equal to a first temperature;
a step 30, if the ambient temperature is higher than or equal to the first temperature, controlling the liquid crystal display device to be normally turned on; otherwise, performing a step 40;
the step 40, determining whether the ambient temperature is higher than or equal to the second temperature, wherein the second temperature is lower than the first temperature; and
a step 50, if the ambient temperature is higher than or equal to the second temperature, controlling a backlight module to be fully turned on in order to heat a liquid crystal panel, and then returning to the step 10.

2. The startup control method for liquid crystal display device according to claim 1, wherein the method further comprises a step of:
a step 60, if the ambient temperature is lower than the second temperature, controlling the liquid crystal display device not to be turned on.

3. The startup control method for liquid crystal display device according to claim 2, wherein the step 60 further comprises a step of: controlling the liquid crystal display device to generate an alarm message.

4. The startup control method for liquid crystal display device according to claim 1, wherein the first temperature is 0° C., the second temperature is minus 20° C.

5. The startup control method for liquid crystal display device according to claim 1, wherein in the step S50, the backlight module is fully turned on to heat the liquid crystal panel through PWM dimming, analog dimming, and/or backlight turning on signal.

6. The startup control method for liquid crystal display device according to claim 1, wherein in the step S10, through a temperature detection circuit to detect the ambient temperature.

7. The startup control method for liquid crystal display device according to claim 6, wherein the temperature detection circuit comprises a thermistor, and through detecting a divided voltage on the thermistor to represent the ambient temperature.

8. The startup control method for liquid crystal display device according to claim 7, wherein the first temperature and the second temperature are respectively represented as a first voltage and a second voltage, confirming the temperature range by comparing the first voltage and the second voltage with the divided voltage, respectively.

9. The startup control method for liquid crystal display device according to claim 8, wherein through comparators to compare the first voltage and the second voltage with the divided voltage.

10. A liquid crystal display device, comprising:
a detection module for detecting an ambient temperature before turning on;
a first determination module for determining whether the ambient temperature is higher than or equal to a first temperature;
a startup module for controlling the liquid crystal display device to be normally turned on if the ambient temperature is higher than or equal to the first temperature;
a second determination module for determining whether the ambient temperature is higher than or equal to a second temperature when the ambient temperature is lower than the first temperature, wherein the second temperature is lower than the first temperature; and
a heating module for controlling the backlight module to be fully turned on to heat the liquid crystal panel if the ambient temperature is higher than or equal to the second temperature.
